(19) United States
(12) Patent Application Publication
(10) Pub. No.: US 2021/0165263 A1
(43) Pub. Date: Jun. 3, 2021

(54) DISPLAY PANEL, DISPLAY APPARATUS AND METHOD FOR MANUFACTURING DISPLAY PANEL

(71) Applicants: Hefei Xinsheng Optoelectronics Technology Co., Ltd., Hefei (CN); BOE Technology Group Co., Ltd., Beijing (CN)

(72) Inventors: Zhenyu Zhang, Beijing (CN); Wenming Ren, Beijing (CN); Ran Zhang, Beijing (CN)

(73) Assignees: Hefei Xinsheng Optoelectronics Technology Co., Ltd.; BOE Technology Group Co., Ltd.

(21) Appl. No.: 16/891,118

(22) Filed: Jun. 3, 2020

(30) Foreign Application Priority Data
Nov. 29, 2019 (CN) 201922107058.7

(51) Int. Cl. G02F 1/1339; G02F 1/1341

(52) U.S. Cl. CPC G02F 1/13394; G02F 2001/13398; G02F 2001/13396; G02F 1/1341

(57) ABSTRACT

A display panel includes: a first substrate; a second substrate, opposite to the first substrate; at least one ring of photo spacers, for supporting opposite surfaces of the first substrate and the second substrate and arranged along edges of the first substrate and the second substrate; and a frame sealant, arranged between the first substrate and the second substrate along the edges of the first substrate and the second substrate and adhered to the first substrate, the second substrate and side walls of the photo spacers respectively.

The present disclosure claims the priority of Chinese Patent Application No. 201922107058.7, filed on Nov. 29, 2019 and entitled “DISPLAY PANEL AND DISPLAY APPARATUS”, which is incorporated herein by reference in its entirety.

### TECHNICAL FIELD

The present disclosure generally relates to the technical field of liquid crystal display, and more particularly to a display panel, a display apparatus, and a method for manufacturing the display panel.

### BACKGROUND

As an important panel display, a touch liquid crystal display has developed rapidly in recent ten years, and has been widely used in modern information devices such as a television, a computer, a mobile phone, a device and the like owing to the advantages of lightness, thinness, low energy consumption and the like.

### SUMMARY

At least one embodiment of the present disclosure provides a display panel. The display panel includes: a first substrate; a second substrate, opposite to the first substrate; at least one ring of photo spacers, for supporting opposite surfaces of the first substrate and the second substrate, and arranged along edges of the first substrate and the second substrate; and a frame sealant, arranged between the first substrate and the second substrate along the edges of the first substrate and the second substrate, and adhered to the first substrate, the second substrate, and side walls of the photo spacers respectively.

At least one embodiment of the present disclosure provides a display panel, including: a first substrate; a second substrate, opposite to the first substrate; a frame sealant, arranged between the first substrate and the second substrate along edges of the first substrate and the second substrate; and a plurality of photo spacers, located between the first substrate and the second substrate, and arranged at intervals in an annular shape along the edges of the first substrate and the second substrate, wherein the photo spacers are directly connected to the first substrate; the first substrate and the photo spacers are both adhered to the second substrate by the frame sealant; one of the first substrate and the second substrate is an array substrate; and the other one of the first substrate and the second substrate is a color film substrate.

At least one embodiment of the present disclosure provides a display apparatus. The display apparatus includes the display panel.

At least one embodiment of the present disclosure further provides a display panel manufacturing method, for manufacturing the display panel described above. The manufacturing method includes: providing a first substrate; forming at least one ring of photo spacers at the edge of a first surface of the first substrate; forming a ring of frame sealant at the edge of a second surface of a second substrate; oppositely arranging the first surface of the first substrate and the second surface of the second substrate, enabling the photo spacers to face the frame sealant; and adhering the first substrate, the second substrate and the photo spacers together via the frame sealant.

At least one embodiment of the present disclosure further provides a display panel manufacturing method, for manufacturing the display panel described above. The manufacturing method includes: providing a first substrate; forming at least one ring of photo spacers and a frame sealant at the edge of a first surface of the first substrate; oppositely arranging the first surface of the first substrate and a second surface of a second substrate; and adhering the first substrate, the second substrate and the photo spacers together by the frame sealant.

### BRIEF DESCRIPTION OF THE DRAWINGS

The other features, objects and advantages of the present disclosure will become apparent by reading the detailed descriptions made for non-restrictive embodiments with reference to the drawings.

FIG. 1 is a perspective view showing a structure of a display panel according to one embodiment of the present disclosure;

FIG. 2 is a sectional view in the A-A direction in FIG. 1;

FIG. 3 is a perspective view showing a structure of another display panel according to one embodiment of the present disclosure;

FIG. 4 is a flow chart of a method for manufacturing a display panel according to one embodiment of the present disclosure;

FIG. 5 is a schematic view of photo spacers disposed on a first substrate of a display panel according to one embodiment of the present disclosure;

FIG. 6 is a structural schematic view of a frame sealant disposed on a second substrate of the display panel according to one embodiment of the present disclosure; and

FIG. 7 is a flow chart of another method for manufacturing display panel according to one embodiment of the present disclosure.

### DETAILED DESCRIPTION

The present disclosure will be further described in detail hereafter in combination with the drawings and embodiments. It can be understood that the specific embodiments described herein are intended to illustrate the present disclosure only, but not to limit the present disclosure. In addition, it should be noted that, to facilitate description, only the parts related to the present disclosure are shown in the drawings.

It should be noted that, in the case of no conflicts, the embodiments in the present disclosure and the features in the embodiments can be mutually combined. The present disclosure will be described in detail hereafter with reference to the drawings and in combination with the embodiments.

In the related art, a display panel of a thin film transistor-liquid crystal display (TFT-LCD) includes a first substrate, a second substrate, a liquid crystal layer located between the first substrate and the second substrate, and a frame sealant for realizing a cell-aligning and connecting the first substrate and the second substrate. The frame sealant is doped with a certain proportion of support particles, for example, plastic balls or silicon balls. After the first substrate and the second substrate are cell-aligned and connected, the support particles in the frame sealant has the effect of retaining cell gap. The support particles doped in the frame sealant have a high manufacturing cost, and thus results to a high material cost of the display panel.

In addition, the first substrate and the second substrate have different thicknesses at various positions; therefore, a periphery between the first substrate and the second substrate cannot be uniformly supported by using the support particles at a uniform height, and the problem cannot be solved even the size of the support particles is adjusted.

Further, the frame sealant doped with the support particles is in contact with the first substrate and the second substrate; peeling gaps are easy to appear among the frame sealant and the second substrate, the first substrate; therefore, the first substrate and the second substrate have a low reliability in the cell-aligning connection. In a high temperature and high humidity environment, water vapor is extremely easy to enter liquid crystal from the peeling gaps, thereby affecting the product quality of a display device.

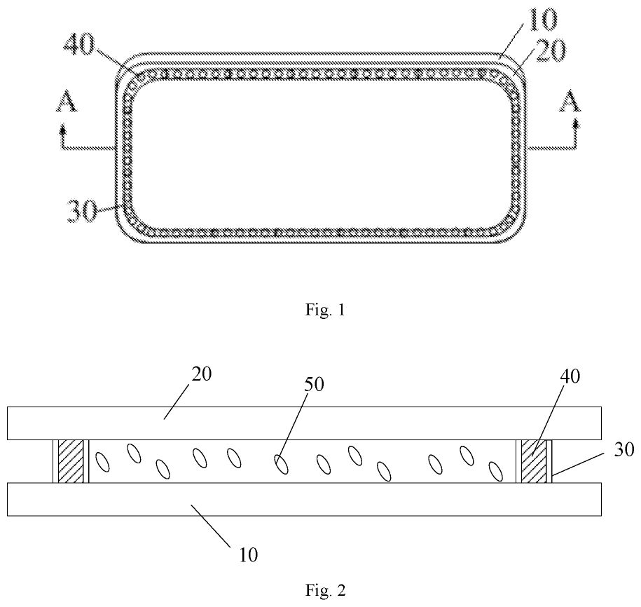

FIG. 1 is a perspective schematic view of a display panel according to one embodiment of the present disclosure. FIG. 2 is a sectional view in the A-A direction in FIG. 1. As shown in FIGS. 1-2, an embodiment of the present disclosure provides a display panel. The display panel includes a first substrate 10 and a second substrate 20 which are disposed oppositely, a frame sealant 30, and at least one ring of photo spacers (PS) 40. The at least one ring of photo spacers 40 is configured to support opposite surfaces of the first substrate 10 and the second substrate 20, and are arranged along edges of the first substrate 10 and the second substrate 20. The frame sealant 30 is arranged between the first substrate 10 and the second substrate 20 along the edges of the first substrate 10 and the second substrate 20. The frame sealant 30 is respectively adhered to the first substrate 10, the second substrate 20, and side walls of the photo spacers 40.

As shown in FIG. 2, a liquid crystal layer 50 is filled between the first substrate 10 and the second substrate 20 and in the frame sealant 30.

In the embodiment of the present disclosure, the photo spacers are adopted as a support skeleton between the first substrate and the second substrate, and can have the effect of retaining cell gap after the first substrate and the second substrate are cell-aligned. No support particles are required to be doped in the frame sealant, and thus the photo spacers have a low cost and can effectively reduce the cost of the display panel.

In the embodiment of the present disclosure, the photo spacers 40 are respectively in contact with the opposite surfaces of the first substrate 10 and the second substrate 20; and the side walls of the photo spacers 40 may refer to surfaces of the photo spacers 40 not in contact with the first substrate 10 and the second substrate 20.

Illustratively, the photo spacers 40 are provided with a first end surface and a second end surface which are opposite in a direction perpendicular to the first substrate. The first end surface is directly connected to the first substrate, that is, the photo spacers 40 are directly formed on the first substrate 10. The second end surface presses against the second substrate, and the photo spacers 40 are adhered to the second substrate 20 via the frame sealant 30. The photo spacers 40 are directly formed on the first substrate 10 and are fixedly connected to the first substrate 10 and the photo spacers 40 are in contact with the frame sealant 30 at the same time. The photo spacers 40 can function as a part of the first substrate 10, thereby improving adhesion areas among the frame sealant 30 and the first substrate 10, the second substrate 20, and effectively improving the reliability of cell-aligning connection between the first substrate 10 and the second substrate 20.

Optionally, as shown in FIGS. 1-2, the frame sealant 30 is adhered to the opposite surfaces of the first substrate 10 and the second substrate 20, and is coated on the side walls of the photo spacers 40; and the side walls of the photo spacers 40 are the surfaces connecting the first end surfaces to the second end surfaces. Therefore, the adhesion areas among the frame sealant 30 and the first substrate 10, the second substrate 20 can be further increased; and the reliability of cell-aligning connection between the first substrate 10 and the second substrate 20 is improved.

It should be noted that in some embodiments, the frame sealant 30 does not need to be coated on the side walls of the photo spacers 40, but are adhered to a part of the side walls of the photo spacers 40 only.

Optionally, one of the first substrate 10 and the second substrate 20 is an array substrate; and the other one of the first substrate 10 and the second substrate 20 is a color film substrate.

Illustratively, the array substrate includes a display region and a peripheral region surrounding the display region, the display region includes a plurality of gate lines and a plurality of data lines; the plurality of gate lines and the plurality of data lines intersect to from a plurality of sub-pixel regions; at least one thin film transistor is disposed in each sub-pixel region, and is configured to control the deflection of the liquid crystal, and accordingly control the display of the display panel. The frame sealant and the at least one ring of photo spacers is located at the peripheral region, and are arranged surrounding the display region.

In a possible embodiment, the array substrate may include a base substrate, and a gate layer (including a gate electrode and gate lines), a gate insulating layer, an active layer, a source/drain layer (including a source electrode, a drain electrode and data lines), a passivation layer and a pixel electrode layer (including a plurality of pixel electrodes) which are stacked on the base substrate. The pixel electrodes are electrically connected to the drain electrode of the source/drain layer via a via hole in the passivation layer.

Illustratively, the base substrate can be a glass substrate, a plastic substrate and the like; the gate insulating layer and the passivation layer can be a silicon nitride or silicon oxynitride layer; the pixel electrode layer can be an indium tin oxide (ITO) thin film layer; the gate layer and the source/drain layer can be a metal electrode layer, for example, Al, Cu, Mo, Cr, Ti and the like, and can also be an alloy electrode layer; the active layer can be made of amorphous silicon, micro-crystalline silicon, or polycrystalline silicon, for example, the active layer may include an amorphous silicon layer disposed on the gate insulating layer, and an N-type doped amorphous silicon layer disposed on the amorphous silicon layer.

Illustratively, the color film substrate may include a base substrate, and a color film layer and a black matrix which are disposed on the base substrate. Light transmission regions of the black matrix are filled with the color film layer. Each sub-pixel region corresponds to one light transmission region, that is, each sub-pixel region corresponds to one color film layer and light emitted from each sub-pixel region has a color after passing through the corresponding color film layer.

In the embodiment of the present disclosure, a plurality of sub-pixel regions form one pixel region, for example, a red sub-pixel region, a green sub-pixel region and a blue sub-pixel region form one pixel region; the color film layer corresponding to the red sub-pixel region is made of a red color barrier block; the color film layer corresponding to the green sub-pixel region is made of a green color barrier block; and color film layer corresponding to the blue sub-pixel region is made of a blue color barrier block.

In a possible embodiment, as shown in FIG. 1, the display panel includes a ring of photo spacers 40, the ring of photo spacers 40 includes a plurality of photo spacers 40; and the plurality of photo spacers 40 are arranged at intervals along the edges of the first substrate and the second substrate. The ring of photo spacers 40 is formed in an edge region of the first substrate 10 or an edge region of the second substrate 20. The structure is simple and it is convenient to process and form the photo spacers.

Optionally, the photo spacers 40 can be columnar photo spacers, for example, the cylindrical photo spacers as shown in FIG. 1; alternatively, the photo spacers can also be prism-shaped photo spacers in other embodiments; the central lines of the columnar photo spacers are perpendicular to a first surface of the first substrate.

Alternately, the photo spacers 40 can also be strip-shaped photo spacers; a length direction of the strip-shaped photo spacers extend along the edge of the first substrate; and the length direction of the strip-shaped photo spacers is in parallel with the first surface.

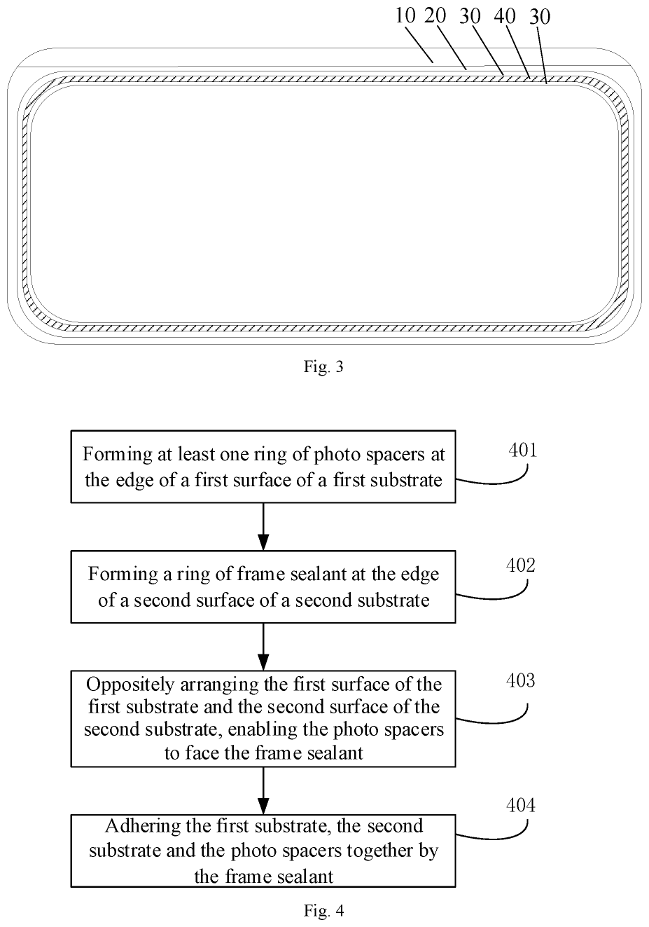

In another possible embodiment, as shown in FIG. 3, the display panel includes a ring of photo spacers 40, and the ring of photo spacers 40 are an annular integrated structure.

In the embodiment of the present disclosure, a manufacturing material of the photo spacers is coated on the first substrate 10, and then the manufacturing material is exposed, developed and baked to form a plurality of photo spacers; and thus the photo spacers 40 are formed on the first substrate 10. A cell-aligning support is formed between the first substrate 10 and the second substrate 20 by the photo spacers. The photo spacers 40 are in contact with the frame sealant 30; and the photo spacers 40, as a support skeleton of the frame sealant 30, function to support the peripheries of the first substrate 10 and the second substrate 20.

It should be noted that the display panels as shown in FIGS. 1 and 3 both include a ring of photo spacers 40, which facilitates the implementation of a narrow-side-frame product. In other embodiments, the display panel may also include more than one ring of photo spacers 40, for example, two rings of photo spacers, so as to improve the adhesion reliability between the first substrate and the second substrate. When the display panel includes more than one ring of photo spacers, one ring can be the photo spacers as shown in FIG. 1, and the other ring can be the photo spacers as shown in FIG. 3.

Optionally, in the embodiment as shown in FIG. 1, the plurality of photo spacers have different heights, the heights are the dimensions of the photo spacers in a direction perpendicular to the first surface of the first substrate; the first surface is a surface on which the photo spacers are disposed, that is, the surface of the first substrate opposite to the second substrate.

Illustrative, the height of a first photo spacer is equal to a difference between a cell gap of the display panel and a thickness of the substrates. The thickness of the substrates is a sum of the thickness of the first substrate corresponding to the first photo spacer and the thickness of the second substrate corresponding to the first photo spacer; and the first photo spacer is any one of the plurality of photo spacers. The first substrate and the second substrate have different film layer structures at different positions, and thus the first substrate has different thicknesses at different positions, and similarly, the second substrate also has different thicknesses at different positions. The heights of the photo spacers are designed to match the thicknesses of the first substrate and the second substrate, such that the photo spacers at different heights can have the effect of uniformly supporting the peripheries of the first substrate 10 and the second substrate 20.

Optionally, the photo spacers can be made of a hydrophobic material which can prevent water vapor from entering the display panel, thereby improving the waterproof performance of the display panel.

Illustratively, the hydrophobic material includes but not limited to an acrylic resinous material.

Optionally, the frame sealant 30 is an ultraviolet-cured frame sealant or a heat-cured frame sealant. The embodiment of the present disclosure does not limit the type and material of the frame sealant as long as the cell-aligning connection of the first substrate and the second substrate can be implemented.

In FIG. 4, an embodiment of the present disclosure further provides a method for manufacturing a display panel. As shown in FIG. 4, the manufacturing method includes:

In step 401, at least one ring of photo spacers is formed at an edge of a first surface of a first substrate.

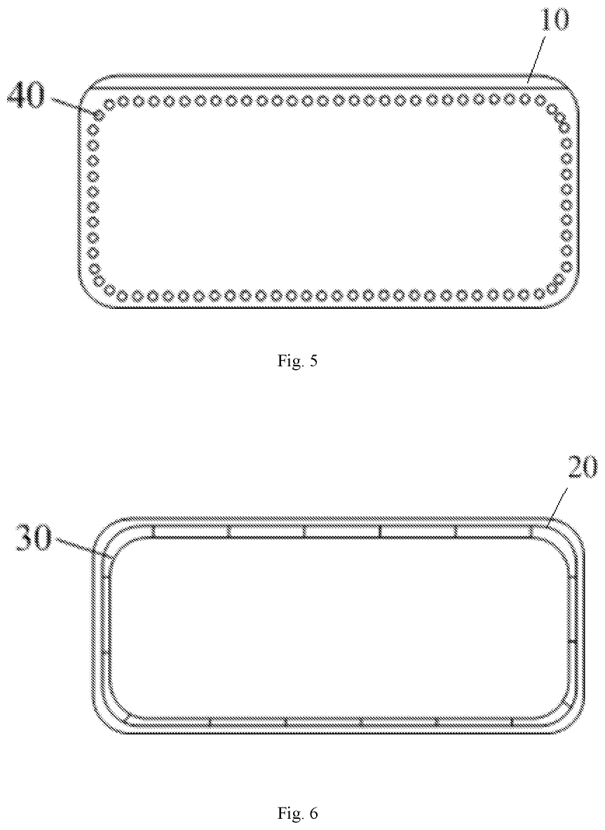

FIG. 5 is a schematic view of photo spacers disposed on the first substrate of the display panel according to one embodiment of the present disclosure. As shown in FIG. 5, a plurality of photo spacers 40 are arranged at intervals in an annular shape at the edge of the first substrate 10, and a ring of photo spacers is formed.

In the embodiment of the present disclosure, a manufacturing material of the photo spacers is coated on the first substrate 10, and then the manufacturing material is exposed, developed and baked to form a plurality of photo spacers and thus the photo spacers 40 are formed on the first substrate 10.

In step 402, a ring of frame sealant is formed at an edge of a second surface of a second substrate.

FIG. 6 is a schematic view a frame sealant disposed on the second substrate of the display panel according to one embodiment of the present disclosure. As shown in FIG. 6, a ring of frame sealant 30 is coated at the edge of the second surface of the second substrate 20.

In step 403, the first surface of the first substrate and the second surface of the second substrate are oppositely arranged to cause the photo spacers to face the frame sealant.

In the step 403, when the first surface of the first substrate and the second surface of the second substrate are oppositely arranged, an orthographic projection of the frame sealant 30 on the first substrate 10 is a first projection region, an orthographic projection of the plurality of photo spacers 40 on the first substrate 10 is a second projection region, and the first projection region overlaps the second projection region. The photo spacers are formed on the first surface of the first substrate, that is, the photo spacers are fixedly connected to the first substrate and the photo spacers can function as a part of the first substrate. When the photo spacers are adhered to the frame sealant, contact areas among the first substrate, the second substrate and the frame sealant can be increased, and thus the adhesion reliability among the frame sealant and the first substrate as well as the second substrate is improved.

Optionally, the first projection region is located in the second projection region, and the photo spacers and the frame sealant are completely faced and are in contact. Therefore, the contact areas among the frame sealant and the first substrate as well as the second substrate are increased, the usage of the frame sealant can be obviously reduced and thus decrease the manufacturing cost of the display panel.

In step 404, the first substrate, the second substrate and the photo spacers are adhered together by the frame sealant.

In the step 404, when the photo spacers face the frame sealant, the first substrate and the second substrate get close to each other until the photo spacers on the first substrate presses against the second substrate, and the frame sealant contacts the opposite surfaces of the first substrate and the second substrate and the side walls of the photo spacers; and then the frame sealant is solidified to adhere the first substrate, the second substrate and the photo spacers together.

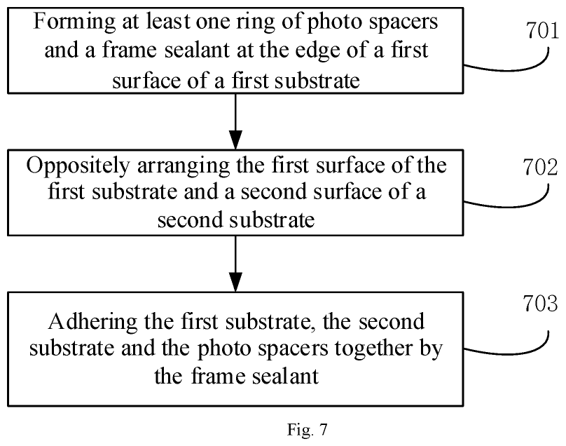

In the embodiment as shown in FIG. 4, the frame sealant is disposed at the edge of the first substrate, the photo spacers at a certain height are disposed at the edge of the second substrate. When the first substrate and the second substrate are cell-aligned, the photo spacers are in contact with the frame sealant and have a good support effect, and the frame sealant has the adhesion effect. In other embodiments, the photo spacers and the frame sealant can also be disposed on the same substrate. For example, FIG. 7 is a flow chart of another method for manufacturing a display panel according to one embodiment of the present disclosure. As shown in FIG. 7, the manufacturing method includes:

In step 701, at least one ring of photo spacers and a frame sealant are formed at an edge of a first surface of a first substrate.

Illustratively, first, at least one ring of photo spacers can be formed at the edge of the first surface of the first substrate; then, a ring of frame sealant is coated. The photo spacers have a certain adhesion effect for the frame sealant, and can limit a flow range of the frame sealant so as to avoid the frame sealant from flowing to a cut line of the display panel, thereby solving the problem of poor cutting.

In step 702, the first surface of the first substrate and a second surface of a second substrate are oppositely arranged.

In step 703, the first substrate, the second substrate and the photo spacers are adhered together by the frame sealant.

The implementation of the step 703 may refer to step 404, and will not be described in detail here.

An embodiment of the present disclosure further provides a display apparatus. The display apparatus includes the display panel provided by any one of the embodiments described above. Illustratively, the display apparatus can be any products or components having a display function, such as a liquid crystal display, a liquid crystal television, a mobile phone, a tablet computer and the like.

In the display panel provided by the embodiments of the present disclosure, the photo spacers are formed on the first substrate, and are in contact with the frame sealant. The photo spacers, as a part of the first substrate, increases the contact areas among the frame sealant and the first substrate as well as the second substrate, and thus increase the adhesive force among the frame sealant and the first substrate as well as the second substrate. At the same time, the contact areas among the frame sealant and the first substrate as well as the second substrate are increased, and the usage of the frame sealant can be reduced, thereby reducing the manufacturing cost of the display panel. In addition, the increase of the contact areas among the frame sealant and the first substrate as well as the second substrate facilitates the acceleration of a solidification process of the frame sealant after being coated, thereby improving the production efficiency of the display panel.

The descriptions above are only the preferred embodiments of the present disclosure and the technical principles applied thereto. A person skilled in the art should understand that the protection scope of the present disclosure is not limited to a technical solution formed by a specific combination of the above technical features, but should also cover other technical solutions formed by any combinations of the above technical features or equivalent features thereof without departing from the concept of the present disclosure. For example, a technical solution formed by mutually substituting the above features and the technical features having similar functions disclosed (but not limited to the technical features) by the present disclosure.

What is claimed is:

1. A display panel, comprising:
a first substrate;
a second substrate, opposite to the first substrate;
at least one ring of photo spacers, for supporting opposite surfaces of the first substrate and the second substrate and arranged along edges of the first substrate and the second substrate; and
a frame sealant, arranged between the first substrate and the second substrate along the edges of the first substrate and the second substrate and adhered to the first substrate, the second substrate and side walls of the photo spacers respectively.

2. The display panel according to claim 1, wherein the one ring of photo spacers comprises a plurality of photo spacers, and the plurality of photo spacers are arranged at intervals in an annular shape along the edges of the first substrate and the second substrate.

3. The display panel according to claim 1, wherein the one ring of photo spacers is an annular integrated structure.

4. The display panel according to claim 2, wherein the plurality of photo spacers have different heights, the heights are the dimensions of the photo spacers in a direction perpendicular to a first surface of the first substrate, and the first surface is a surface on which the photo spacers are disposed.

5. The display panel according to claim 4, wherein the height of a first photo spacer is equal to a difference between a cell gap of the display panel and a thickness of substrates, the thickness of the substrates is a sum of a thickness of the first substrate corresponding to the first photo spacer and a thickness of the second substrate corresponding to the first photo spacer, and the first photo spacer is any one of the plurality of photo spacers.

6. The display panel according to claim 5, wherein photo spacers are provided with a first end surface and a second end surface which are opposite in a direction perpendicular to the first surface of the first substrate; the first end surface is directly connected to the first substrate; and the second end surface presses against the second substrate.

7. The display panel according to claim 6, wherein the frame sealant is adhered to the opposite surfaces of the first substrate and the second substrate and is coated on the side walls of the photo spacers and the side walls of the photo spacers are surfaces connecting the first end surfaces to the second end surfaces.

8. The display panel according to claim 1, wherein the photo spacers are made of a hydrophobic material.

9. The display panel according to claim 1, wherein one of the first substrate and the second substrate is an array substrate; and the other one of the first substrate and the second substrate is a color film substrate.

10. A display panel, comprising:
a first substrate;
a second substrate, opposite to the first substrate;
a frame sealant, arranged between the first substrate and the second substrate along edges of the first substrate and the second substrate; and
a plurality of photo spacers, located between the first substrate and the second substrate, and arranged at intervals in an annular shape along the edges of the first substrate and the second substrate, wherein the photo spacers are directly connected to the first substrate; the first substrate and the photo spacers are both adhered to the second substrate by the frame sealant; and
wherein one of the first substrate and the second substrate is an array substrate; and the other one of the first substrate and the second substrate is a color film substrate.

11. A display apparatus, comprising a display panel, wherein the display panel comprises:
a first substrate;
a second substrate, opposite to the first substrate;
at least one ring of photo spacers, for supporting opposite surfaces of the first substrate and the second substrate and arranged along edges of the first substrate and the second substrate; and
a frame sealant, arranged between the first substrate and the second substrate along the edges of the first substrate and the second substrate, and adhered to the first substrate, the second substrate and side walls of the photo spacers respectively.

12. The display apparatus according to claim 11, wherein the one ring of photo spacers comprises a plurality of photo spacers, and the plurality of photo spacers are arranged at intervals in an annular shape along the edges of the first substrate and the second substrate.

13. The display apparatus according to claim 12, wherein the plurality of photo spacers have different heights, the heights are the dimensions of the photo spacers in a direction perpendicular to a first surface of the first substrate, and the first surface is a surface on which the photo spacers are disposed.

14. The display apparatus according to claim 13, wherein the height of a first photo spacer is equal to a difference between a cell gap of the display panel and a thickness of substrates; the thickness of the substrates is a sum of a thickness of the first substrate corresponding to the first photo spacer and a thickness of the second substrate corresponding to the first photo spacer, and the first photo spacer is any one of the plurality of photo spacers.

15. The display apparatus according to claim 14, wherein photo spacers are provided with a first end surface and a second end surface which are opposite in a direction perpendicular to the first surface of the first substrate; the first end surface is directly connected to the first substrate;
and the second end surface presses against the second substrate.

16. The display apparatus according to claim 15, wherein the frame sealant is adhered to the opposite surfaces of the first substrate and the second substrate, and is coated on the side walls of the photo spacers; and the side walls of the photo spacers are surfaces connecting the first end surfaces to the second end surfaces.

17. The display panel according to claim 11, wherein the photo spacers are made of a hydrophobic material.

18. A method for manufacturing the display panel as claimed in claim 1, comprising:
forming at least one ring of photo spacers at the edge of a first surface of a first substrate;
forming a ring of frame sealant at the edge of a second surface of a second substrate;
oppositely arranging the first surface of the first substrate and the second surface of the second substrate, enabling the photo spacers to face the frame sealant; and
adhering the first substrate, the second substrate and the photo spacers together by the frame sealant.

19. A method for manufacturing the display panel as claimed in claim 1, comprising:
forming at least one ring of photo spacers and a frame sealant at the edge of a first surface of a first substrate;
oppositely arranging the first surface of the first substrate and a second surface of a second substrate; and
adhering the first substrate, the second substrate and the photo spacers together by the frame sealant.
